(19) United States
(12) Patent Application Publication
(10) Pub. No.: US 2024/0315286 A1
(43) Pub. Date: Sep. 26, 2024

(54) METHOD AND APPARATUS TO CONCURRENTLY SUPERCOOL DIFFERENT PERISHABLES

(71) Applicant: EverCase, Inc., Wimberley, TX (US)

(72) Inventors: Christopher Phillippe Somogyi, Wimberley, TX (US); Mark Samuel Freeman, Redmond, WA (US); Paul Vernon Budak, Marysville, WA (US); David Mark Schluneker, San Antonio, TX (US)

(21) Appl. No.: 18/189,950

(22) Filed: Mar. 24, 2023

(51) Int. Cl. A23L 3/32; A23L 3/00; A23L 3/36

(52) U.S. Cl. CPC A23L 3/32; A23L 3/001; A23L 3/36

(57) ABSTRACT

A method and apparatus as disclosed in the present disclosure may provide supercooling functionality for a wide range of perishable items. Supercooling may be accomplished by using at least one of magnetic fields, electric fields, displacement current, or a combination thereof. Supercooling of the perishable items may be accomplished by selecting specific parameters (e.g., power amplitudes, waveforms, frequencies, and duty cycles) of the least one of magnetic fields, electric fields, or displacement current to drive the electronics that create these energies. Different perishable items may require different combinations of these parameters to achieve optimal supercooling effects. Different combinations of the parameters may be applied to different perishable items so that different type of perishable items can be supercooled concurrently or simultaneously. Further, the different combinations of the parameters may be applied at any time relative to one another.

### BACKGROUND

### Technical Field

The present disclosure is generally related to the field of preserving the freshness of perishable products (e.g., food products, biological products such as tissue, organs harvested for transplantation, vaccine, or the like) while stored at temperatures below the products' freezing point.

### Description of the Related Art

The preservation of food products is a critical aspect of public health. Among the various methods of food preservation, chilling foods helps to slow the process of decomposition and the growth of contaminating microbial species. Freezing is one of the common methods for ensuring the safety of food products and retaining the quality of foods over long storage periods. Despite its effectiveness, the process of freezing and thawing poses significant problems with respect to the quality of the foods. For instance, during the freezing process ice crystallization and growth can result in irreversible damage to tissue structures in meat, fish, fruit, and vegetables, such as structural ruptures and changes in osmotic pressure. Other changes observed that occur in food products during the freezing and thawing process include changes in the food's sensory properties such as color, taste, and freshness. Food products subjected to excessively prolonged freezing may also experience lipid oxidation, protein denaturation, ice recrystallization, and changes in the moisture content. These degrading effects on the quality of food products are directly related to the degree of structural damages to the food products caused by the formation, growth, and distribution of ice crystals within the food products. Such problems associated with freezing food products show the importance of controlling the formation and growth of ice crystals within food products during the storage period.

### BRIEF SUMMARY

One or more embodiments of the present disclosure addresses the various technical problems in the related art including the problems identified above.

In one embodiment, a method according to the present disclosure includes controlling a temperature of a perishable product in a container to a selected temperature range. The method includes applying an oscillating magnetic field to the perishable product in the container while maintaining the temperature of the perishable product within the selected temperature range. The method includes applying a pulsed electric field to the perishable product in the container concurrently with the oscillating magnetic field while maintaining the temperature of the perishable product within the selected temperature range. Here, the pulsed electric field has a selected duty cycle. The method includes adjusting the selected duty cycle of the pulsed electric field based on a type of the perishable product.

In another embodiment, a method according to the present disclosure includes controlling a temperature of one or more perishable products in a container to a selected temperature range. The method includes applying an oscillating magnetic field to the one or more perishable products in the container while maintaining the temperature of the perishable product within the selected temperature range. The method includes applying a pulsed electric field to the one or more perishable products in the container concurrently with the oscillating magnetic field while maintaining the temperature of the perishable product within the selected temperature range. Here, the pulsed electric field has a selected duty cycle. The method includes applying a first duty cycle of the pulsed electric field to a first type of perishable product of the one or more perishable products. The method also includes applying a second duty cycle of the pulsed electric field to a second type of perishable product of the one or more perishable products. In the embodiment, the first type of perishable product and the second type of perishable product are different from each other.

In yet another embodiment, a method according to the present disclosure includes controlling a temperature of a perishable product in a container to a selected temperature range. The method includes applying at least one of a magnetic field, an electric field, or a displacement current to the perishable product in the container while maintaining the temperature of the perishable product within the selected temperature range. The applying of at least one of a magnetic field, an electric field, or a displacement current to the perishable product includes selecting a combination of power, amplitudes, waveforms, frequencies, and duty cycles of the at least one of a magnetic field, an electric field, or the displacement current. The applying of at least one of a magnetic field, an electric field, or a displacement current to the perishable product also includes applying the selected combination of power, amplitudes, waveforms, frequencies, and duty cycles to the perishable product.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless the context indicates otherwise. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Moreover, some elements known to those of skill in the art have not been illustrated in the drawings for ease of illustration. One or more embodiments are described hereinafter with reference to the accompanying drawings in which:

FIG. 1 shows a supercooling apparatus for perishable products according to some embodiments of the present disclosure;

FIG. 2 is a schematic drawing of the arrangements of the electrodes and the electromagnets according to one embodiment of the present disclosure;

FIG. 3A is a drawing of the process of ice crystallization under freezing condition according to the related art;

FIG. 3B is a drawing of the process of ice crystallization under freezing condition according to one embodiment of the present disclosure;

FIG. 4 illustrates a stepwise control of pulsed electric field and oscillating magnetic field during supercooling;

FIG. 5 shows two different duty cycles that are applied to two different perishable products, respectively, inside a supercooling apparatus shown in FIG. 1 according to one embodiment;

FIG. 6 shows two different duty cycles that are applied to two different perishable products, respectively, inside a supercooling apparatus shown in FIG. 1 according to one embodiment;

FIG. 7A shows various different types of perishable products provided within a container having multiple sensors according to one embodiment of the present disclosure;

FIG. 7B shows various different types of perishable products provided within a container having multiple sensors according to another embodiment of the present disclosure;

FIG. 7C shows multiple sensors disposed in respective regions of a container in a plan view;

FIG. 8 is a flow chart of a method according to one embodiment of the present disclosure;

FIG. 9 is a flow chart of a method according to another embodiment of the present disclosure;

FIG. 10 is a flow chart of a method according to yet another embodiment of the present disclosure; and

FIG. 11 is an example system diagram of a supercooling system including the supercooling apparatus shown in FIG. 1.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to interfaces, power supplies, physical component layout, etc., have not been shown or described in order to avoid unnecessarily obscuring descriptions of the embodiments. Additionally, the various embodiments may be methods, systems, or devices.

Throughout the specification, claims, and drawings, the following terms take the following meanings, unless the context indicates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context indicates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context indicates otherwise. In addition, throughout the specification, the meaning of “a,” “an,” and “the” include singular and plural references.

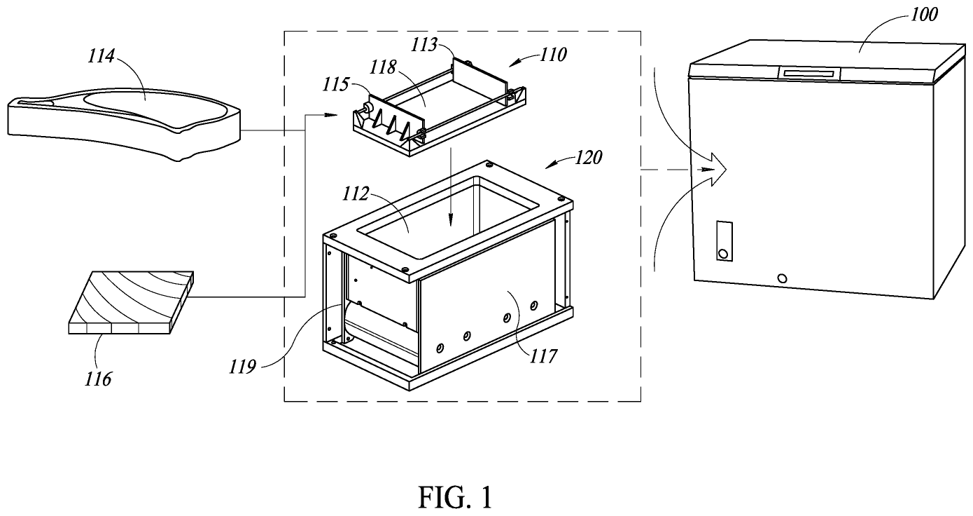

FIG. 1 shows a supercooling apparatus for perishable products according to some embodiments of the present disclosure.

Supercooling can be defined as the process of cooling the temperature of a perishable product below its freezing temperature without ice crystal formation. The supercooling function according to the present disclosure may be accomplished by using at least one of magnetic field, electric field, displacement current, or a combination thereof.

As illustrated, a supercooling apparatus 100 (hereinafter “apparatus”) includes a first structure 110 (hereinafter “the first structure”) for applying an electric field and a second structure 120 (hereinafter “the second structure”) for applying a magnetic field. The first structure 110 is provided within a space 112 of the second structure 120 and one or more perishable products 114, 116 are provided on a tray portion 118 of the first structure 110.

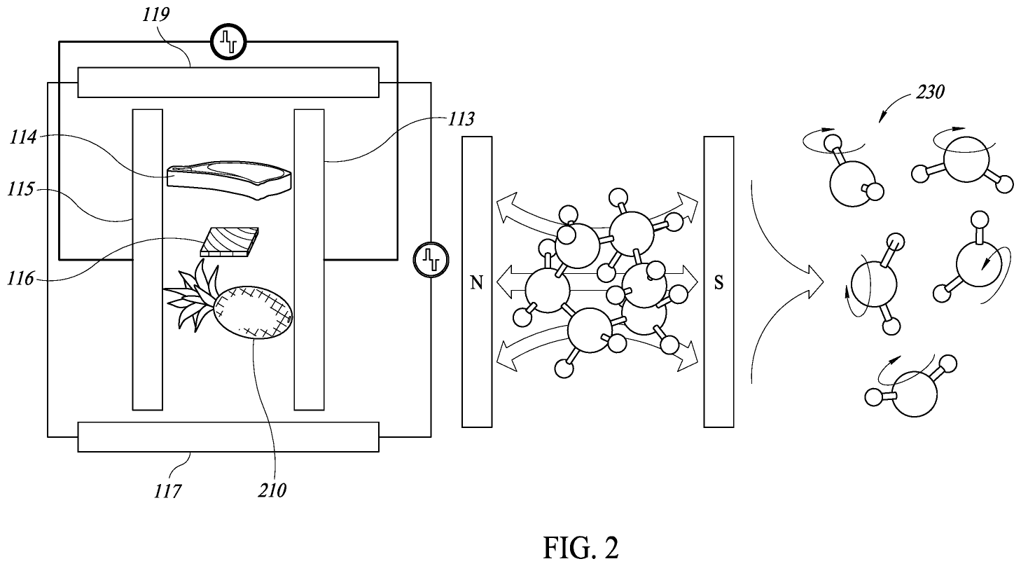

In one embodiment, the first structure 110 includes a first electrode 113 and a second electrode 115 opposite the first electrode for applying electric fields to the perishable products placed between the first and second electrodes. The second structure 120 includes a first electromagnet 117 and a second electromagnet 119 (see FIG. 2) for applying oscillating magnetic fields to the perishable products. The configuration shown in FIG. 1 is merely an example and other structures and arrangements can be used to apply electric fields and oscillating magnetic fields to the perishable products. For example, a solenoid configuration, may be used to apply oscillating magnetic fields within the space 112. In one embodiment, the second structure 120 can be implemented as a solenoid so that the magnetic field within the space 112 is uniform. For example, any suitable solenoid configuration or segmented solenoids arranged in multiple coil Helmholtz row can be utilized. This arrangement and configuration allow the magnetic field to be swept across the length of the path perpendicular to the windings of the solenoid.

Similarly, the first structure 110 is configured to apply a pulsed electric field between the first and second electrodes 113, 115. In one embodiment, a uniform pulsed electric field can be applied to the supercooling apparatus 100 or the supercooling container.

The apparatus 100 according to the present disclosure provides the supercooling functionality for a wide range of different types of perishable products.

According to some embodiments, at least one of a magnetic field, electric field, or displacement current is applied to the perishable product in order to achieve the supercooling functionality.

Based on the type of perishable product, only an oscillating magnetic field may be applied to achieve the supercooling functionality. Based on yet another type of perishable product, a combination of a pulsed electric field, oscillating magnetic field, or displacement current may be applied to achieve the supercooling functionality. The pulsed electric fields as used herein refers to electric fields generated based on contacting electrodes. The displacement current as used herein refers to current generated based on non-contacting electrodes. Displacement current is one form of the electric field current. In one or more embodiments, at least one of a magnetic field, electric field, displacement current or certain combinations thereof may be used based on the type of perishable product inside the apparatus 100.

In operation, the apparatus 100 is provided within a conventional refrigerator or freezer in order to control a temperature of the perishable product in the apparatus to a selected temperature range. The selected temperature range may be between 0° Celsius and −80° Celsius depending on the perishable product.

The term “perishable product” is used broadly herein to include any type of perishable materials and substances. A typical example may include food products. The food products may include, but are not limited to, meat products (e.g., beef, pork, or the like), seafood products (e.g., shellfish, fish, crustaceans, mollusks, or the like), poultry products (e.g., chicken), vegetables, fruits (pineapples, berries, stone fruit, etc.), dairy products, prepared meals, etc. The perishable products also include biological products, including organs, tissues, biologics, cell cultures, stem cells, embryos, blood (e.g., whole blood, red blood cells, platelets, plasma, or the like), reactive solutions, vaccines, sperm, unstable chemical reagents, flowers, or any item requiring cooled storage.

In FIG. 1, two different types of perishable products are illustrated. According to one or more embodiments, the apparatus 100 can concurrently supercool different types of perishable products that are placed within the apparatus 100 by applying a magnetic field, electric field, or displacement current that is generated according to specific signal parameters (or hereinafter simply “parameters”) based on the types of the perishable products inside the apparatus.

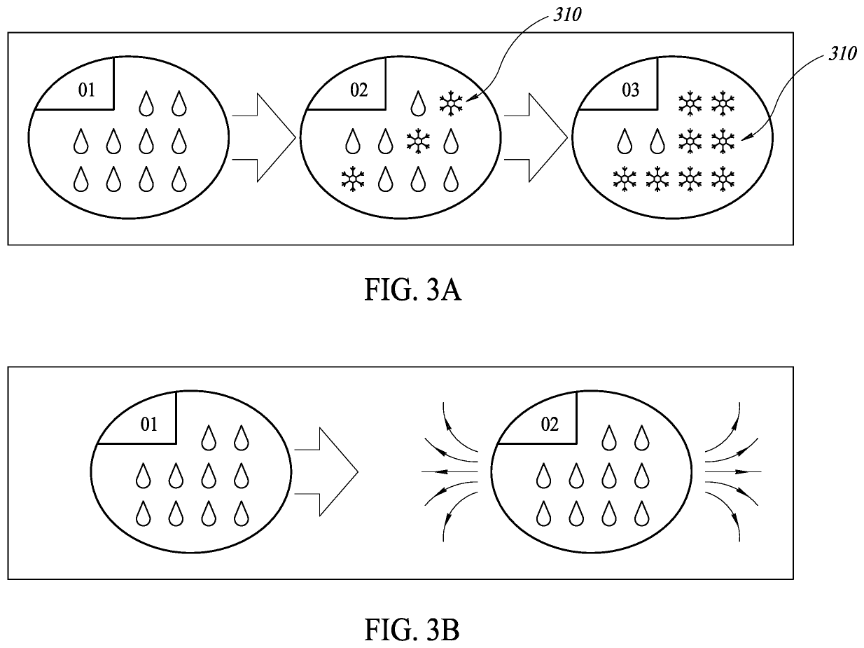

For instance, each magnetic field, electric field, or displacement current may be associated with parameters such as, but not limited to, strength (e.g., magnetic flux density), amplitudes, power level, type of waveforms (e.g., sine wave, square wave, exponential decay, or jagged, or stair stepped, etc.), frequencies, carrier frequency, vector, duty cycles, phase information, etc. The combination of applying at least one of magnetic fields, electric fields, or displacement current drives the electronics which prevent, for example, water molecules from acting as an ice nucleation site inside the perishable product. That is, the external electric field and magnetic field affects the onset of ice crystal formation during freezing and supercooling processes because water consists of dipole molecules and is also diamagnetic. Accordingly, the water molecules that are naturally present in the perishable product tend to realign and re-orientate under electric and magnetic fields, which makes it possible to prevent the ice crystallization process by applying the appropriate pulsed electric field and oscillating magnetic field. This process is further detailed in connection with FIGS. 2 and 3.

In one or more embodiments, different combinations of the parameters may be set and applied to at least one of magnetic fields, electric fields, or displacement current to perform the supercooling function to the different types of perishable products. Various different combinations of the parameters may be used for different types of perishable products. In one embodiment, the parameters may be determined based on the use of dielectric spectroscopy which measures the dielectric properties of a medium as a function of frequency. A frequency response of various types of food products can also be used to determine the parameters of the magnetic fields, electric fields, and displacement current.

In one embodiment, the various types of food products such as chicken breast or tuna can be modeled as a resistor. In other embodiments, the various types of food products can be modeled as medium having dielectric properties. The appropriate parameters to apply for different types of food products can be determined based on interrogating the food product by sending various input signals and sensing the output signals obtained at the other end of the food product using sensors.

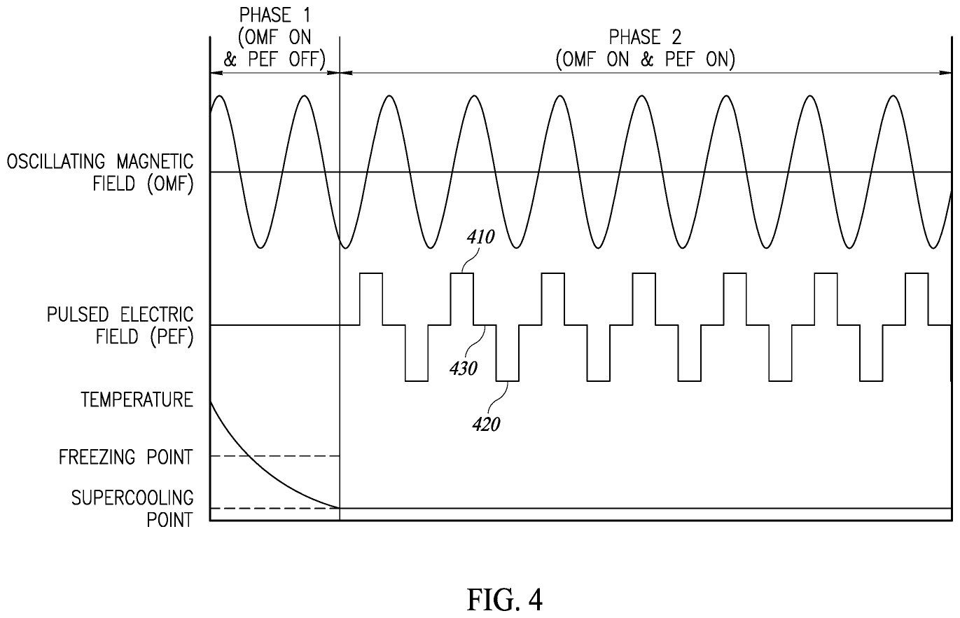

FIG. 2 is a schematic drawing of the arrangements of the electrodes and the electromagnets according to one embodiment of the present disclosure. FIG. 3A is a drawing of the process of ice crystallization under freezing condition according to the related art. FIG. 3B is a drawing of the process of ice crystallization under freezing condition according to one embodiment of the present disclosure. FIG. 4 illustrates a stepwise control of a pulsed electric field and an oscillating magnetic field during supercooling of a food product.

FIG. 2 shows an example arrangement of the electrodes 113, 115 and the electromagnets 117, 119 for achieving and maintaining a supercooled state in the perishable products (beef 114, tuna 116, and pineapple 210). To control supercooling, a combination of a pulsed electric field (PEF) and an oscillating magnetic field (OMF) can be applied to the perishable products. The combination of pulsed electric field and oscillating magnetic field influences the mobility of water molecules 230. According to one or more embodiments, pulsed electric field and oscillating magnetic field is applied inside the apparatus. Further, as described previously, in order to apply oscillating magnetic field inside the apparatus various types of electromagnets may be used including solenoids. Using the combination of pulsed electric field and oscillating magnetic field, stable supercooled products can be obtained through the continuous reorientation and induced vibration of water molecules, thereby suppressing the formation of ice as shown in FIG. 3B.

According to one embodiment, the pulsed electric field and the oscillating magnetic field may be orthogonal with respect to each other.

In another embodiment, the pulsed electric field and the oscillating magnetic field may be parallel with respect to each other.

In yet another embodiment, the pulsed electric field and the oscillating magnetic field may have an arbitrary angle with respect to each other.

Referring to FIGS. 3A, 3B and 4, the phenomenon of supercooling may be understood in the context of the ice crystallization process. Ice crystallization can be divided into three subsequent stages: cooling the liquid-state product to its freezing point, removing the latent heat of crystallization during the phase transition, and cooling the solid-state product to the final storage temperature.

In a supercooling process, water cools below the freezing temperature until a critical nucleation point is reached by the removal of sensible heat (see FIG. 3). Ice nucleation is a stochastic process. The negative difference between the temperature at this nucleation point and the standard freezing point is referred to as the degree of supercooling. Depending on the physical conditions of the system, e.g., pressure, temperature, volume, and cooling rate after a certain degree of supercooling, a sudden nucleation of water crystals occurs. Thereafter, the ice crystals become more compact and undergo crystallization to bulk ice crystals.

By preventing water molecules from forming a cluster of a critical size that results in ice nucleation, a water-containing material can be maintained in the supercooled state, thus impeding a phase transition to its frozen state. Alternatively, the formation of ice crystals within the material can be controlled, only allowing small ice crystals which do not damage the perishable material. Due to the dipole structure of water molecules, an electric field can be applied to a water-containing material and the types of waveform, frequency, interpulse duration (duty ratio) and field strength of an electric field can be modified to control the discharge and realignment of water molecules along the direction of the electric field. Similarly, due to its diamagnetic properties, the magnetic fields make an impact on the intermolecular structure of water.

The conventional freezing process as shown in FIG. 3A cannot avoid the ice crystallization process thereby at least partially damaging the cell structure of the perishable product due to the volumetric expansion.

In some embodiments, the method of supercooling a perishable product, such as a food product, comprises cooling the perishable product to a temperature below its freezing point while applying a pulsed electric field and oscillating magnetic field to the perishable product. The pulsed electric field and oscillating magnetic field are maintained while the product is stored in the supercooled state in the apparatus 100. In some embodiments, the product does not freeze in the supercooled state. In some embodiments, the perishable product is a product that contains water.

In some embodiments, the perishable product is first cooled while applying an oscillating magnetic field. In some embodiments, the pulsed electric field is not applied at this time depending on the type of perishable product. For example, the product can be supercooled by being placed in the apparatus 100, while an oscillating magnetic field is applied. Once the product has reached a supercool temperature, the pulsed electric field is added and the combination of the pulsed electric field and oscillating magnetic field is maintained for as long as the product is to be stored at a supercooled temperature as detailed in FIG. 4.

Referring to FIG. 4, the time when the oscillating magnetic field is on and the pulsed electric field is off can be referred to as a first phase PHASE 1, while the time when both the oscillating magnetic field and the pulsed electric field are provided can be referred to as a second phase PHASE 2. In some embodiments, the perishable product is cooled while applying the oscillating magnetic field and the pulsed electric field is added when the temperature has stabilized. In some embodiments, the perishable product is cooled while applying the oscillating magnetic field and the pulsed electric field is added when a desired temperature has been reached. For example, the pulsed electric field may be added when a temperature at which the perishable product is to be stored has been reached. In some embodiments, the temperature may be between about −1° C. and about −20° C., for example about −7° C. or about −8° C. In some embodiments, the product is cooled while applying both the oscillating magnetic field and the pulsed electric field, and both are maintained during storage.

The use of the pulsed electric field and the oscillating magnetic field suppresses the nucleation of ice crystals 310 in the perishable product (see FIG. 3A) and the product attains a supercooled state without freezing (see FIG. 3B). The pulsed electric field and oscillating magnetic field can be maintained in order to maintain the perishable product at the supercooled state for an extended period of time, thus maintaining the quality of the product. However, as shown in FIG. 3A, in the related art, when the freezing process occurs, ice is formed and the formation of ice crystals includes negative effects such as irreversible damage to cell structure due to the volumetric expansion of water in the perishable products.

In some embodiments, the perishable product is cooled to a selected temperature that is lower than the freezing temperature of the product. In some embodiments, the perishable produce is cooled to a selected temperature that is lower than the freezing temperature of water, or 0° C. In some embodiments, the selected temperature can be between −1° C. and −20° C. However, the selected temperature range may vary depending on the type and amount of the perishable product.

In some embodiments, the pulsed electric field is applied as a squared waveform. In some embodiments, the squared waveform can have a frequency of about 0 to about 100 kHz. In some embodiments, the frequency is about 20 Hz or below.

In some embodiments, the squared waveform can be provided with a duty cycle of about 0.1 to about 0.9. As will be explained in detail later on, the duty cycle applied depends on the type of perishable product in the container as well as the amount of perishable product in the container.

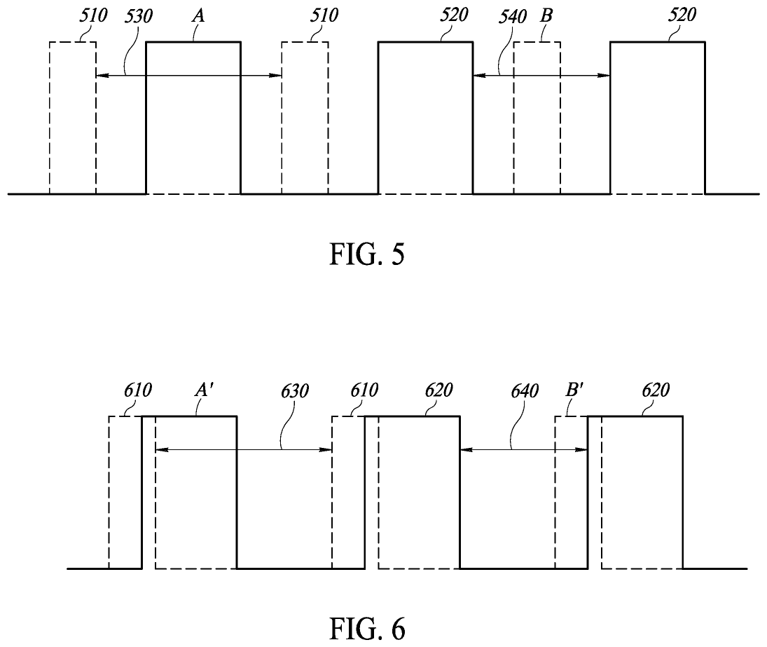

In some embodiments, more than one duty cycle can be used during application of a pulsed electric field to the perishable products. In some embodiments, a mixed sequence of duty cycles is used depending on the different types and amount of perishable products present in the container as shown in FIGS. 5 and 6. While FIGS. 5 and 6 each show an example combination of duty cycles, other parameters are also considered along with the duty cycles in order to apply different magnetic fields and electric fields for different type of perishable products to achieve the supercooling effect. For instance, not only duty cycles but also magnitude, amplitude, direction of magnetic field, direction of electric field, frequency, phase, waveform (e.g., wave shape) are also adjusted in order to apply the suitable different magnetic fields and electric fields according to the different type of perishable products (e.g., foods or flowers or medical goods, etc.).

In some embodiments, one or more duty cycles are applied for the same length of time. For example, each duty cycle may be carried out for the same length of time throughout the time that the PEF is provided. In some embodiments, each duty cycle is carried out for a different length of time. A sequence of duty cycles applied for particular lengths of time may also be repeated one or more times during application of the PEF.

In some embodiments, the pulsed electric field has a strength of about 0.6 V/cm to about 10 V/cm. Further, in some embodiments, the strength of the pulsed electric field may vary as function of dimensions and characteristics of the perishable product.

In some embodiments, the oscillating magnetic field has a strength of about 0 mT to 100 mT (milliTesla) as measured at the center of the chamber holding the perishable product.

In some embodiments, the oscillating magnetic field is within the container by use of a solenoid structure. In some embodiments, the oscillating magnetic field may be about 10 mT or less.

The methods described herein may impede ice crystal formation as depicted in FIG. 3B. In some embodiments, the perishable product does not freeze during supercooling or while maintained in a supercooled state. In some embodiments, the perishable product is less frozen than the same type of product maintained at the same temperature for the same amount of time, but that is not subjected to PEF and OMF as described herein. In some embodiments, no ice crystals are formed within the supercooled perishable product. In some embodiments, finer ice crystals are formed in the perishable product than are formed in the same type of perishable product under similar conditions without the application of both the pulsed electric field and the oscillating magnetic field. In some embodiments, any ice crystals that may form do not negatively affect the sensory properties and/or intended use of the perishable product.

In some embodiments, the perishable product is maintained in a supercooled state for at least 24 hours while continuing to apply the pulsed electric field and the oscillating magnetic field. In some embodiments, the perishable product is maintained in a supercooled state for at least 72 hours while continuing to apply the pulsed electric field and the oscillating magnetic field. In some embodiments, the perishable product is maintained in a supercooled state for at least two weeks while continuing to apply the pulsed electric field and the oscillating magnetic field. In some embodiments, the perishable product is maintained in a supercooled state for a month or more. In one or more embodiments, the perishable product does not freeze during the time that it is maintained in the supercooled state.

However, in other embodiments, the pulsed electric field may be intermittently turned off and need not be continuously turned on for 72 hours, two weeks, a month, or any selected period. In this embodiment, intermittently turning off the pulsed electric field will not affect the freshness of the perishable product stored in the container and the perishable product will maintain the supercooled state.

In addition, in some embodiments, the perishable product does not need to be continuously maintained in a supercooled state by continuing to apply the pulsed electric field and oscillating magnetic field. That is, the duty cycle of the pulsed electric field (or ON time of the PEF) may be less than 100% thereby reducing power consumption as compared to having to continuously apply the pulsed electric field during a selected period of time. Further, intermittently turning off the pulsed electric field according to a certain duty cycle will not impact the freshness of the perishable product and will also maintain the unfrozen state.

A person of ordinary skill in the art can appreciate that merely applying a selected duty cycle of a pulsed electric field waveform less than 100% to all of the perishable products in the apparatus equally will produce a different result from a power consumption standpoint compared to applying different selected duty cycles for each perishable product depending on its food type. That is, each perishable product may require a different duty cycle less than 100% that ensures the freshness of the item in a supercooled state. For example, if there are pork, salmon, and pineapple which are all different types of food products (e.g., meat, seafood, fruit) inside the apparatus, applying a 0.4 duty cycle of a pulsed electric field waveform equally to all of pork, salmon, and pineapple can result in consuming more power than necessary than the threshold duty cycle for maintaining freshness. For instance, if a pork requires a 0.4 duty cycle and a salmon requires a 0.3 duty cycle and a pineapple requires a 0.1 duty cycle, applying 0.4 duty cycle to all of the different types of food products in the apparatus leads to more power consumption that could have been otherwise avoided. As shown in FIG. 5, the duty cycle can be applied in a time-multiplexing manner where duty cycle A and duty cycle B are spaced apart from each other in time and do not overlap with each other thereby applying different duty cycles to different food products, respectively, in the same space within the apparatus 100.

A food product is preserved in a supercooled state such that its qualities do not significantly change from a fresh product. For example, in some embodiments, the drip loss from a piece of meat that has been preserved using the described methods is not significantly different from the drip loss in a fresh piece of the meat. Similarly, in some embodiments, there is no significant change in tenderness in the food, such as a piece of meat, after the supercooling process. That is, there is not a significant difference between the tenderness of a piece of meat or other food that has been treated as described and a fresh piece of the same meat or food. In some embodiments, no structural differences are observable between a fresh piece of food and a piece of the same food that has been preserved as described. In some embodiments, there is no change in color between food (or other product) that has been preserved as described relative to a fresh piece of the same food (or other product).

In addition, the methods described herein can be used to preserve organs or other tissues after harvest and prior to transplantation or other use. The organs or tissues may come, for example, from a human or animal. In some embodiments, the organ is a human organ to be used for transplantation. In this way, the quality of the organs or tissues can be maintained during transport, storage and preparation. In some embodiments, methods of maintaining an organ or other tissue in a supercooled state comprise supercooling the organ or tissue by cooling to a temperature below its freezing point, such as in a range of about 0° C. to about −20° C., or about −4° C. to about-7° C., while applying an oscillating magnetic field (and, in some embodiments, a pulsed electric field) to the organ or tissue, essentially as described above. The temperature of the organ or tissue may be maintained within the range of about −4° C. to about −7° C. for an extended time while applying both the pulsed electric field and the oscillating magnetic field to the organ or tissue. In some embodiments, the temperature is maintained for at least 24 hours, or at least 72 hours. In some embodiments, the temperature is maintained for two weeks or more. Preferably, the organ or tissue remains viable for its intended use throughout the time that it is maintained in a supercooled state.

In some embodiments, the methods may be used to preserve other types of materials such as biologics, cell cultures, stem cells, embryos, blood, reactive solutions, and unstable chemical reagents.

In some embodiments, methods of maintaining a vaccine in a supercooled state comprise supercooling the vaccine by cooling to a temperature below its freezing point.

Cooling of perishable products in the present methods can be carried out in any of a variety of refrigerators or freezers. A supercooling apparatus 100 as described herein can be included as part of a commercial refrigeration or freezing unit. That is, the apparatus 100 may be part of a larger refrigerator or freezer, or other apparatus. For example, it may be a built-in part of a refrigeration or freezing unit. In another example, the supercooling apparatus may take the form of a drawer or compartment in a refrigerator, freezer or other cooling device. In such a configuration, the apparatus can serve as a supercooling storage compartment. In some embodiments, the supercooling storage compartment may be removable.

In some embodiments, the apparatus can be manufactured independently. In some embodiments, the apparatus is portable and comprises cooling elements as well as the supercooling components. For example, the apparatus can be portable and can be placed into a larger refrigerator or a refrigeration or freezing unit. The freezer can be set to the desired temperature to begin the supercooling process.

FIG. 5 shows two different duty cycles that are applied to two different perishable products, respectively, inside a supercooling apparatus shown in FIG. 1 according to one embodiment.

In FIG. 5, there are two different duty cycles A and B of a pulsed electric field waveform. The PEF waveform of duty cycle A has pulses 510 that are monophasic and are separated by an inter-pulse delay 530 that is measured from one polarity pulse to the next pulse of the same polarity. This is one example of a pulsed electric field and other forms of waveform (e.g., sine wave) can be applied. Further, in some embodiments, the pulsed electric field can be biphasic. As shown in FIG. 4, the PEF waveform have two pulses that are each biphasic wherein each cycle is comprised of one polarity phase 410 followed by an opposite polarity phase 420. There is also a delay 430 between one polarity phase 410 and an opposite polarity phase 420.

Similar to duty cycle A, duty cycle B has pulses 520 that are monophasic and are separated by an inter-pulse delay 540.

Pulsed electric fields are created through rapid discharge of electrical energy within a finite period of time. Such pulses follow a pattern known as a waveform (as illustrated in FIG. 5), which represents how an electrical current varies over time. Common waveforms for electrical currents include the square wave, the sine wave, the ramp, the sawtooth wave, the raised cosine wave, the Gaussian wave, the triangular wave, exponential decay, or jagged, or stair stepped, or the like. In a squared waveform (as shown in FIG. 5), the amplitude of the wave alternates at a steady frequency between fixed minimum and maximum values, with the same duration at minimum and maximum. As described in FIGS. 5 and 6, in these embodiments, a squared waveform is used in applying a PEF to a perishable product.

In addition to having a waveform, the pulsed electric fields can follow a duty cycle, as discussed briefly above. A duty cycle (or “power cycle”) is the fraction of one period in which a signal or system is active. Duty cycle is commonly expressed as a percentage or a ratio and the duty cycle values range between 0 and 1. In addition, a period is the time it takes for a signal to complete an on-and-off cycle. As a formula, a duty cycle (%) may be expressed as: D=PW/T where D is the duty cycle, PW is the pulse width (pulse active time), and T is the total period of the signal (or the time the signal is active). Duty cycles can be programmed to deliver a desired amount of electrical energy in packets over a given period of time. Such duty cycles can further be programmed to follow a sequence in which D and PW are varied as the sequence progresses. For instance, each signal event may be different in terms of amplitude, vector, phase with other signals, wave shape, frequency, and duty cycle.

A non-limiting example of a duty cycle sequence suitable for supercooling and maintaining a supercooled state in water-containing perishable materials follows the sequence 0.8 for a period of 300 seconds, 0.5 for a period of 120 seconds, and 0.2 for a period of 90 seconds. Another non-limiting example of a duty cycle sequence suitable for supercooling and maintaining a supercooled state in water-containing perishable materials follows the sequence 0.8 for a period of 300 seconds, 0.5 for a period of 120 seconds, and 0.2 for a period of 120 seconds. The sequence can be repeated for a defined duration of time or indefinitely.

As mentioned previously, merely applying a selected duty cycle of a pulsed electric field waveform less than a 100% to all of the perishable products in the apparatus simultaneously may consume more power compared to applying different selected duty cycles suitable for each perishable product depending on its food type.

Each perishable product may have a unique, threshold duty cycle that is less than 100% (any value ranging from 0 to 1) that ensures the freshness of the item in a supercooled state. For example, referring to FIG. 1, a beef 114 may have 0.4 duty cycle as a threshold duty cycle. That is, if the applied PEF waveform has a duty cycle equal to or greater than 0.4 duty cycle, the beef 114 may stay fresh in a supercooled state. On the other hand, tuna 116 (which is a different type of food compared to beef 114) may have 0.2 duty cycle as a threshold duty cycle. Under these conditions, applying 0.4 duty cycle of a pulsed electric field waveform equally to beef 114 and tuna 116 can result in consuming more power that necessary than the threshold duty cycle for maintaining freshness. In FIG. 5, duty cycle A is applied to the beef 114 and duty cycle B is applied to the tuna 116. As shown in FIG. 5, the duty cycles can be applied in a time-multiplexing manner where duty cycle A and duty cycle B are spaced apart from each other in time and do not overlap with each other. That is, the high pulses (or “active” period or “ON” period) of a signal having duty cycle B do not overlap with high pulses of a signal having duty cycle A.

FIG. 6 shows two different duty cycles that are applied to two different perishable products, respectively, inside a supercooling apparatus shown in FIG. 1 according to one embodiment.

The PEF waveform of duty cycle A′ has pulses 620 that are monophasic and are separated by an inter-pulse delay 640. Similarly, duty cycle B′ has pulses 610 that are monophasic and are separated by an inter-pulse delay 630.

Contrary to the example shown in FIG. 5, duty cycle A′ and duty cycle B′ at least partially overlap each other in time. That is, the high pulses of a signal having the duty cycle B′ at least partially overlap with high pulses of a signal having duty cycle A′. For certain types of similar food products, the duty cycles of the PEF waveforms applied to the food products can be designed to overlap each other.

In some embodiments, the duty cycle applied depends on the type of perishable product in the container as well as the amount of perishable product in the container.

In some embodiments, more than one duty cycle can be used during application of a pulsed electric field to the perishable products. In some embodiments, a mixed sequence of duty cycles is used depending on the different types and amount of perishable products present in the container as shown in FIGS. 5 and 6.

In some embodiments, one or more duty cycles are applied for the same length of time. For example, each duty cycle may be carried out for the same length of time throughout the time that the PEF is provided. In some embodiments, each duty cycle is carried out for a different length of time. A sequence of duty cycles applied for particular lengths of time may also be repeated one or more times during application of the PEF.

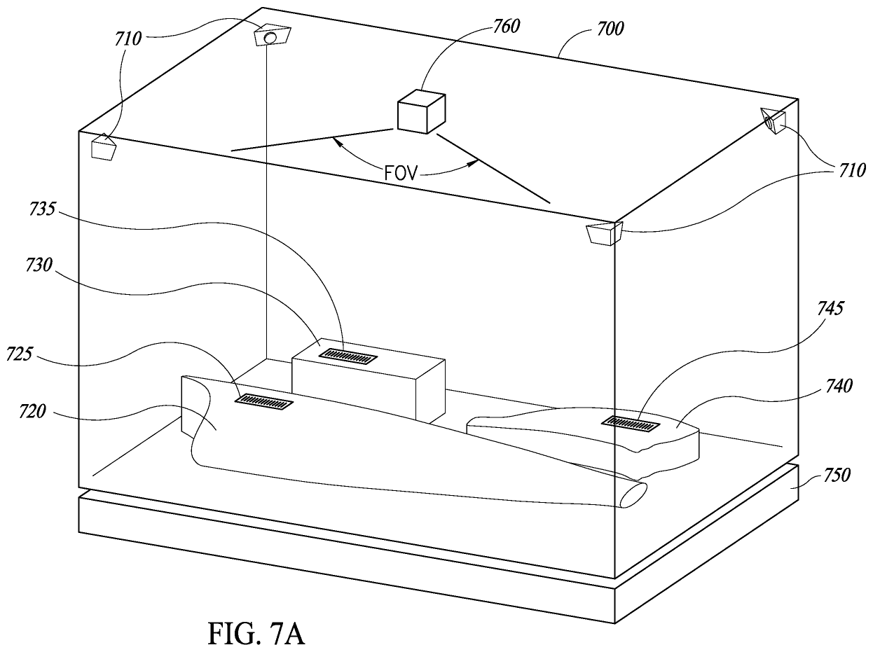

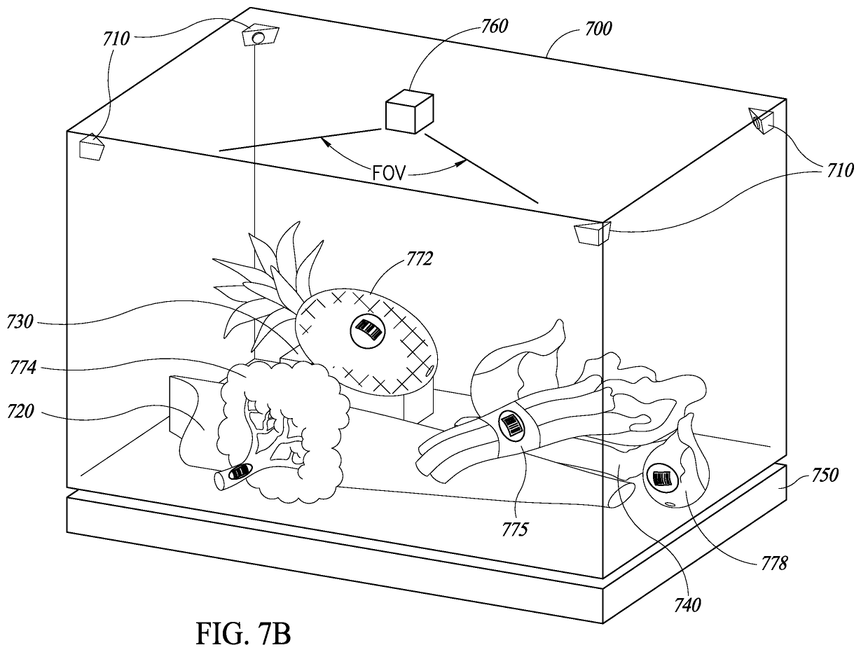

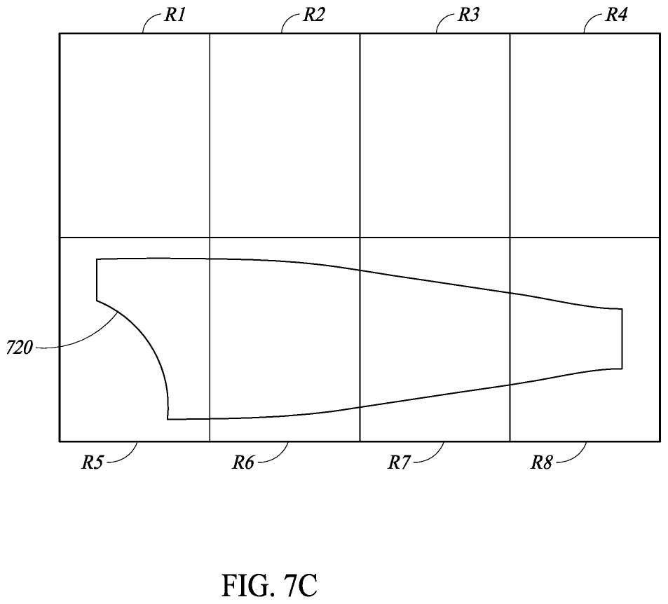

FIG. 7A shows various different types of perishable products provided within a container having multiple sensors according to one embodiment of the present disclosure. FIG. 7B shows various different types of perishable products provided within a container having multiple sensors according to another embodiment of the present disclosure. FIG. 7C shows multiple sensors disposed in respective regions of a container in a plan view.

In one or more embodiments, the supercooling apparatus (as shown in FIG. 1) can be used to implement the above-described methods for supercooling perishable products. In one embodiment, the apparatus 100 comprises a container 700 capable of storing one or more perishable products. In one embodiment, the container 700 may be provided in a space 112 of the second structure 120. In another embodiment, the container 700 may be provided to house both the first structure 110 and the second structure 120.

The apparatus 100 also includes one or more pulsed electric field generators (not shown) comprising electrodes positioned to contact (either directly or indirectly) the one or more perishable products when they are placed in or coupled to the container 700. The apparatus 100 may also include one or more oscillating magnetic field generators (not shown) arranged to form an oscillating magnetic field within or coupled to the container 700. As described previously, a solenoid configuration may be used. In one embodiment, the magnetic field generated within the space of the container 700 is uniform.

As shown in FIG. 7A, the container 700 may include various types of sensors for obtaining various characteristics of the perishable products inside the container 700. Here, the first structure 110 and the second structure 120 of the supercooling apparatus 100, as well as the electric field generators and the oscillating magnetic field generators, are not shown here for simplicity.

According to some embodiments, the various type of sensors may be located at different positions within the container to obtain information required for identifying the type and amount of perishable products in the container. The type of sensors utilized include, but are not limited to, image sensors, scanners, weight sensors, quantity sensors, distance sensors, or the like.

In one embodiment, the sensors may be image sensors 710 to obtain images of the perishable products (e.g., salmon 720, cheese 730, steak 740, each having attached machine-readable symbols 725, 735, 745, respectively, for uniquely identifying the respective item). A controller (not shown) electrically connected to the sensors may receive the images of the perishable products and perform an image analysis to determine the type of the perishable products and the amount of the perishable products in the container 700. The controller electrically connected to the first structure 110 for applying an electric field and the second structure 120 for applying a magnetic field may then control the parameters (e.g., power levels, amplitudes, waveforms, frequencies, and duty cycles) associated with the magnetic field, the electric field, and displacement current according to the different type and amount of perishable products identified within the container.

By applying a first set of combinations of parameters to the salmon 720, and applying a second set of combinations of parameters to the cheese 730, and applying a third set of combinations of parameters to the steak 740, the perishable products (720, 730, 740) in the container can be supercooled in the same space based on applying three different combinations of parameters according to different type of perishable products. However, as described in connection with FIGS. 5 and 6, based on the closeness or the similarity of the type of perishable product, the duty cycle of the pulsed electric field can be spaced apart in time as shown in FIG. 5 or at least partially overlap with each other as shown in FIG. 6. For instance, for a cheese 730, a first set of duty cycle B can be applied and for a salmon 720, a second set of duty cycle A can be applied that do not overlap each other in time. On the other hand, for a steak 740, a first set of duty cycle B′ can be applied, and for a salmon 720, a second set of duty cycle A′ can be applied that at least partially overlap each other in time. In one embodiment, the properties of a medium and the similarity of its properties can be determined through dielectric spectroscopy, which measures the dielectric properties of a medium as a function of frequency. Above is merely an example and other various methods can be used to determine the dielectric properties of a medium.

Referring to FIG. 7A, in another embodiment, the sensors may include weight sensors 750. The weight sensors may be disposed at the bottom of the container 700 to determine the weight and amount of the perishable products. For example, a weight sensor may be placed under each region as shown in FIG. 7C and data from the weight sensor may be transmitted to the controller. The image sensors 710 and the weight sensors 750 as well as other sensors (e.g., quantity sensors, time of flight sensors, or the like) may be both present within the container 700 in order to improve the accuracy of determining the type and the amount of the perishable products within the container 700.

In one embodiment, the sensors may include readers or scanners capable of reading various symbols directly or indirectly attached to the perishable products. The various symbols may include, but are not limited to, barcodes, quick response (QR) codes, wireless tags (e.g., RFID), or any machine-readable symbols including a combination of characters (numeric, alphanumeric), patterns, figures, or the like.

In some embodiments, the readers capable of interpreting machine-readable symbols may be incorporated with the image sensors 710.

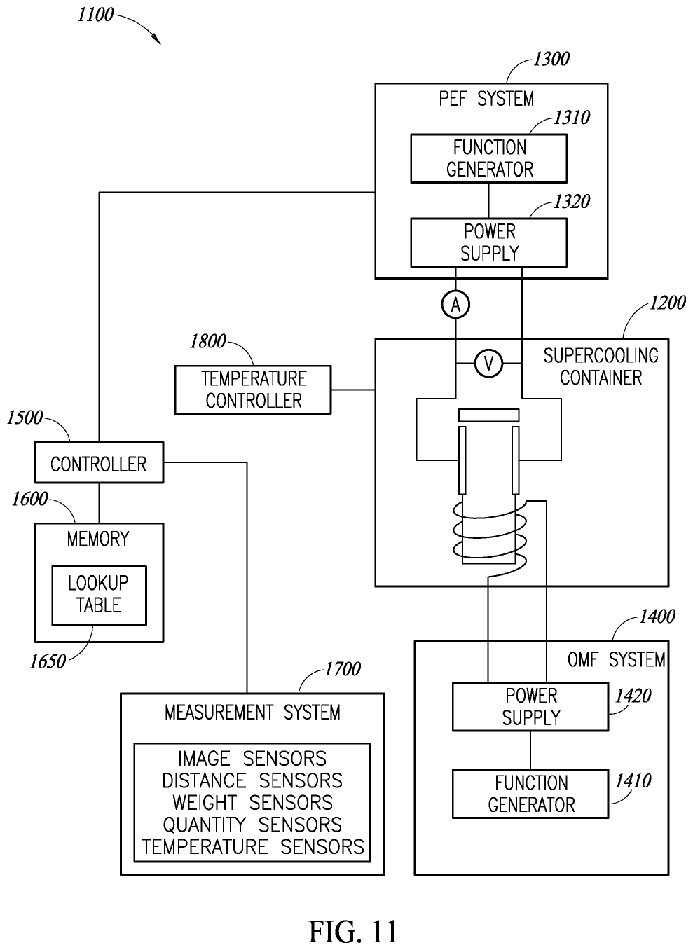

The sensors may read the barcodes or the QR codes or the wireless tags (e.g., RFID) associated with certain perishable product to quickly identify the type of the perishable product. In some cases, the barcodes or the QR codes may not be visually obtainable (see FIG. 7B where the machine-readable symbols of salmon 720, cheese 730, and steak 740 are blocked from the view of the image sensors 710 by other items 772, 774, 775, 778). In these cases, the various sensors including image sensors and weight sensors or other sensors (e.g., quantity sensors, time of flight sensors) may operate together to obtain information for determining the type and amount of perishable products. In some embodiments, the various information obtained through the various type of sensors can be used to train an artificial intelligence (AI) model that can be embedded into an artificial intelligence image processing circuitry coupled to a controller 1500 (see FIG. 11). The AI model may be trained using any type of suitable AI algorithm that is capable of analyzing sensor data (e.g., image analysis) and outputting a predicted value that is substantially identical to an actual value. As will be explained later in detail, the AI image processing circuitry and a controller 1500 operatively coupled to the AI image processing circuitry can be located outside the supercooling container. That is, by having a processing unit such as the AI image processing circuitry or the controller 1500 elsewhere, complex analyses or large collective data sets that drive AI pattern analyses can be efficiently managed. Further, the training data and the AI model may be continuously updated to further improve the accuracy of the prediction.

In some embodiments, the controller may retrieve information from a lookup table (LUT) stored in a memory (not shown) electrically connected to the controller. The controller may obtain the various information collected from the various sensors and also retrieve information from a lookup table to determine the type of the perishable product.

For instance, the lookup table may be previously created and stored based on historical data of various different types of perishable products in the market. The lookup table may store, for example, the various colors of an apple, an average weight information of an apple, various shapes, contours of an apple, or other identifiable distinguishing features of an apple. Accordingly, even if the barcode attached to the apple is somehow blocked from the scanners, the image sensors can determine the color of the apple as well as the shape of the apple as well as other distinguishing features of the apple and compare to the lookup table storing the corresponding data (or retrieve the closest data). If the various data collected from the sensors are within the range stored in the lookup table, the controller may determine that the perishable product may likely be an apple. In order to increase the accuracy, the controller may also retrieve the weight information collected from the weight sensors and determine whether the weight of the apple obtained is within the typical weight range of an apple as stored in the lookup table in order to properly determine the type of perishable product inside the container. The example features of colors, shapes, contours, weight stored in the above example lookup table is merely an example and other features for distinguishing the type of a perishable product can be stored and utilized.

The use of a lookup table can be useful as it can significantly reduce the processing time of the controller because retrieving a value from a memory is often faster than carrying out a complex computation (e.g., image processing analysis).

In some embodiments, the supercooling apparatus 100 may include or communicatively be coupled to a database as a way to store and retrieve information. In another embodiment, cloud storage or computing support for the supercooling apparatus 100 can be provided. For instance, multiple supercooling apparatus may be utilized by various different users at different locations and each data collected from the respective supercooling apparatus may transmit data and information into a cloud data store for real time or later processing purposes.

In some embodiments, the container 700 may include temperature sensors to measure the temperature of the perishable product inside the supercooling apparatus 100. For example, a variety of temperature sensing mechanisms such as thermistors and lasers may be utilized.

In some embodiments, the container 700 may include distance sensors 760 or range sensors 760. FIG. 7A shows the container 700 including a distance sensor 760 positioned on the upper surface opposite of the bottom surface of the container 700. The distance sensor 760 or distance sensors 760 (while only one is shown in FIG. 7A, many distance sensors 760 may be present at various locations including the sidewall of the container or the bottom surface of the container, etc.) may be positioned at a location where the field of view (FOV) of the distance sensor covers substantially all areas of the container 700. More than one distance sensors may be used in order to obtain distance information to recreate the inside of the container 700 in a 3-dimensional (3D) manner to determine the type and amount of the perishable product.

One non-limiting example of distance sensor is a time of flight (ToF) sensor. Time of flight (ToF) is the measurement of the time taken by an object to travel a distance through a medium. This information can then be used to measure velocity or path length, or as a way to learn about the particle or medium's properties (such as composition). A time-of-flight sensor (ToF sensor) is an example of a distance sensor and is a range imaging camera system for measuring distances between the sensor and the subject for each point of the image based on time-of-flight, the round trip time of an artificial light signal, as provided by a laser or an LED. Time of flight is merely an example and other type of distance sensors utilizing laser pulse or laser beam can be used. Further, multiple distance sensors may be used and deployed at different locations of the upper surface of the container rather than one distance sensor 760 located in the center of the upper surface of the container 700 as shown in FIG. 7A. Having multiple distance sensors can obtain data to recreate the scene in a 3-dimensional (3D) manner to determine the type of the perishable product.

In some embodiments, the controller can activate one or more weight sensors 750 on the bottom surface of the container 700. Instead of utilizing a single weight sensor that is capable of weighting the total weight of the items inside the container, there can be a plurality of weight sensors disposed in multiple regions (R1, R2, R3, . . . R8) of the bottom surface, respectively, in order to accurately measure the weight of the individual items inside the container (see FIG. 7C).

Referring to FIG. 7C, the salmon 720 is arranged in a length direction of the container and overlaps with regions R5, R6, R7, and R8. Since each region (R1, R2, R3, . . . R8) has weight sensors disposed there beneath, the controller can add the weight detected from regions R5, R6, R7, and R8 and calculate the weight of the salmon 720.

One or more embodiments may utilize quantity sensors that measure or infer a quantity of a perishable product in combination with image analysis (which is used to infer the type of a product based on the visual appearance) or other analysis as described above to increase accuracy of perishable items inside the container 700.

The bottom surface of the container 700 may be divided into one or more regions as shown in FIG. 7C, and a quantity sensor may be associated with each region. The quantity signal generated by the quantity sensor may be correlated with the number of items in the region. The controller may analyze quantity signals to determine how many items are currently present in each region of the container 700.

In order to increase the accuracy of the determination, the controller may concurrently obtain camera images of the regions (as collected by image sensors 710), weight data of the regions (as collected by weight sensors 750), and distance information of the regions (as collected by distance sensors 760).

The quantity sensors associated with each region (R1, R2, R3, . . . R8) of the bottom surface may be positioned on the bottom surface or upper surface of the container corresponding to each region. For instance, one or more quantity sensors associated with region R1 may be positioned on either the bottom surface or upper surface of the container or both in region R1. Similarly, one or more quantity sensors associated with region R2 may be positioned on either the bottom surface or upper surface of the container or both in region R2.

The quantity sensors measure the distance between the sensor and the associated perishable item located in the corresponding region. Distance measurement may use any sensing technology, including for example, without limitation, LIDAR, ultrasonic range finding, or the like.

While the various types of sensors discussed above may be present in the container 700, the controller may not activate and utilize all the sensors present in the container 700. For example, in situations where all of the perishable products are arranged in a way that can be easily analyzed through only some of the sensors, the controller may not activate the rest of the sensors in order to reduce power consumption and reduce using processing resources.

For instance, in FIG. 7A, only a single image sensor 710 may be utilized to identify the type and amount of the perishable product present in the container as the machine-readable symbols 725, 735, 745 of salmon 720, cheese 730, steak 740, respectively, are easily obtainable by image analysis or simply reading the machine-readable symbols. In these cases, the distance sensors 760, the rest of the image sensors 710 (i.e., the 3 image sensors in the rest of the upper corner of the container), the weight sensors 750, and the quantity sensors may not be activated.

In FIG. 7B, there are more perishable products within the container and the machine-readable codes of the salmon 720, the cheese 730, and the steak 740 are occluded by a pineapple 772, a broccoli 774, a leek 775, and an onion 778. That is, although image sensors may be positioned and oriented to view the plane where the perishable products are located, some of the perishable products may occlude some of the views of the image sensors for reading the machine-readable symbols attached to the perishable products. Further, in some cases, one of the machine-readable symbols of the items may not be oriented in a direction of the field of view of the image sensors.

In one or more embodiments, the controller may receive the images taken from the image sensors and determine whether all of the different types of perishable products in the container have been identified.

Activating the machine-readable symbol scanners (or simply “scanners”) will only be able to obtain the amount and type of product of the pineapple 772, the broccoli 774, the leek 775, and the onion 778. If the controller determines that some of the items were unable to be identified, the controller may activate one or more different types of sensors to obtain the information of the identified item. In one embodiment, if one of the image sensors has an obstructed view and is unable to identify the type of perishable product, the controller may activate another image sensor positioned at a different location that does not have an obstructed view.

If the other image sensors are not able to identify the type of perishable product, the controller may utilize the image sensors as well as the weight sensors, the time of flight sensors, the lookup table, the quantity sensors, and many other resources to properly and accurately identify the type and amount of perishable products inside the container.

For instance, using the image sensors 710 and the distance sensors 760, the controller will be able to recreate a scene in a 3D image for all the perishable products (720, 730, 740, 772, 774, 775, and 778) inside the container 700. Based on the scanners as well as the image, distance, and weight sensors, the items of 772, 774, 775, 778 can be removed through image reconstruction of the scene. Further, the weight of the times of 772, 774, 775, 778 can be removed or subtracted so that the weight of the occluded products (720, 730, 740) can be obtained. Based on the image analysis (e.g., color, shape, texture, as well as other characteristics visually obtainable from image sensors) and the distance measurement analysis using the distance sensors/quantity sensors (e.g., features such as the contours, the shape, the depth, the dimension, quantity, the texture information as well as other features obtainable through the distance/quantity sensors), even though the machine-readable symbols of items 720, 730, 740 are occluded, the data collected from the various sensors and also using the lookup table, the controller can accurately determine the type and amount of perishable products occluded. Further, as described above, various trained AI models may also be used to assist the image analysis.

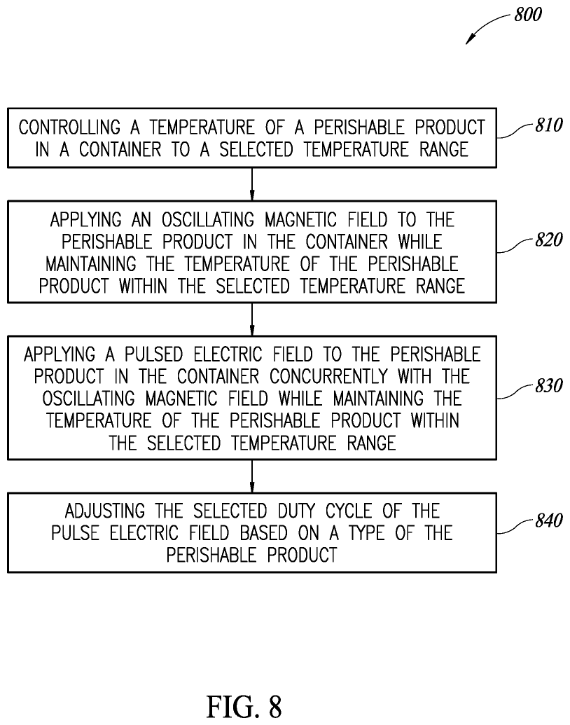

FIG. 8 is a flow chart of a method according to one embodiment of the present disclosure. The method describes the steps of the supercooling functionality for a wide range of perishable products. For instance, each magnetic field, electric field, displacement current may be associated with parameters such as, but not limited to, strength (e.g., magnetic flux density), amplitudes, power level, type of waveforms (e.g., sine wave, square wave, etc.), frequencies, duty cycles, phase information, etc. The combination of applying at least one of magnetic fields, electric fields, or displacement current drives the electronics which prevents, for example, water molecules from acting as an ice nucleation site. That is, the external electric field and magnetic field affects the onset of ice crystal formation during freezing and supercooling processes because water consists of dipole molecules and is also diamagnetic (see FIGS. 2, 3A, and 3B). Accordingly, the water molecules naturally present in perishable product tend to realign and re-orientate under electric and magnetic fields, which makes it possible to prevent the ice crystallization process by applying the appropriate pulsed electric field and oscillating magnetic field.

In one embodiment, the method 800 includes controlling a temperature of a perishable product in a container 700 to a selected temperature range (at 810). The selected temperature range may be between 0° Celsius and −80° Celsius depending on the perishable product. For example, when the perishable product is seafood product including fish, the temperature may be about −20° Celsius. When the perishable product is a tissue sample, a vaccine, or semen, the temperature may be about −80° Celsius to about −60 ° Celsius.

The method 800 includes applying an oscillating magnetic field to the perishable product in the container 700 while maintaining the temperature of the perishable product within the selected temperature range (at 820). The method 800 includes applying a pulsed electric field to the perishable product in the container concurrently with the oscillating magnetic field while maintaining the temperature of the perishable product within the selected temperature range (at 830).

The method 800 also includes adjusting the selected duty cycle of the pulsed electric field based on a type of the perishable product (at 840). In one or more embodiments, the pulsed electric field may have a selected duty cycle based on the different type of perishable products. A duty cycle is the fraction of one period in which a signal or system is active. Accordingly, a 70% duty cycle means the signal is on 70% of the time but off 30% of the time. The “on time” for a 70% duty cycle depends on the length of the period.

The container which includes the first structure for applying electric field and the second structure for applying magnetic field is coupled to a power source so that power can be delivered to the first and second structures. According to some embodiments, the pulsed electric field can have a duty cycle that is not 100% for certain types of perishable products. Namely, for a certain type of perishable product, once the perishable product enters into a supercooled state by cooling the temperature of the perishable product and applying the oscillating magnetic field and the pulsed electric field, the power supplied to the container can be turned off for a selected period of time (or the pulsed electric field may be turned off for a selected period of time) and the perishable product would still maintain its freshness and unfrozen state.

The feature of applying a pulsed electric field that does not have a 100% duty cycle has some technical benefits in that continuously powering on the container to supply a 100% duty cycle pulsed electric field to maintain the freshness of the perishable product can be power consuming and expensive. By applying a specific duty cycle of the pulsed electric field based on a specific type of perishable product can both achieve less power consumption and freshness of the perishable product.

For instance, referring to FIG. 5, a salmon and a pineapple may be placed inside the container. The salmon and the pineapple may enter into a supercooled state by first controlling the temperature so that the temperature of the salmon and the pineapple is in a selected temperature range. Thereafter or concurrently, an oscillating magnetic field and a pulsed electric field are applied to the salmon and the pineapple while maintaining the temperature within the selected temperature range. After the salmon and the pineapple enter into a supercooled state, a first duty cycle of the pulsed electric field that is less than a 100% can be applied to the salmon. A second duty cycle that is different from the first duty cycle can be applied to the pineapple. Here, the ON time of the first duty cycle and the ON time of second duty cycle do not overlap each other in time.

In some embodiments, the container may have a first pair of electrodes for applying the first duty cycle for the first type of perishable product (here, the salmon) and the second duty cycle for the second type of perishable product (here, the pineapple).

In another embodiment, the container may further include a second pair of electrodes for applying the second duty cycle. In this embodiment, the ON time of the first duty cycle based on the first pair of electrodes and the ON time of second duty cycle based on the second pair of electrodes may overlap each other in time as shown in FIG. 6.

In some embodiments, adjusting the selected duty cycle of the pulsed electric field based on a type of the perishable product comprises applying a first duty cycle of the selected duty cycle when the perishable product is either a fish product or a meat product.

In some embodiments, adjusting the selected duty cycle of the pulsed electric field based on a type of the perishable product comprises applying a second duty cycle of the selected duty cycle when the perishable product is either a fruit product or a vegetable product.

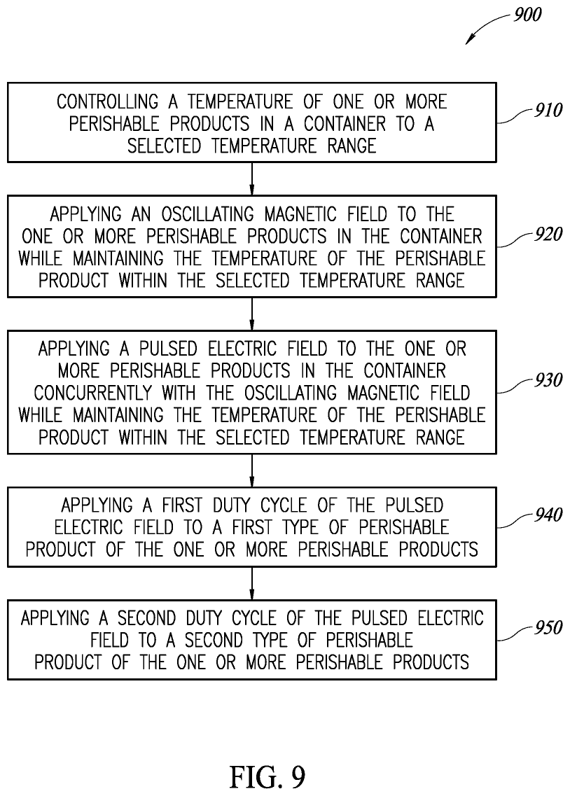

FIG. 9 is a flow chart of a method according to another embodiment of the present disclosure.

The method 900 includes the method of applying two different duty cycles to different types of perishable products inside the container, respectively.

The method 900 includes controlling a temperature of one or more perishable products in a container to a selected temperature range (at 910). The method 900 includes applying an oscillating magnetic field to the one or more perishable products in the container while maintaining the temperature of the perishable product within the selected temperature range (at 920). The method 900 includes applying a pulsed electric field to the one or more perishable products in the container concurrently with the oscillating magnetic field while maintaining the temperature of the perishable product within the selected temperature range (at 930). The method 900 includes applying a first duty cycle of the pulsed electric field to a first type of perishable product of the one or more perishable products (at 940). The method 900 includes applying a second duty cycle of the pulsed electric field to a second type of perishable product of the one or more perishable products (at 950).

In one embodiment, the first duty cycle that is applied to the first type of perishable product may be different from the second duty cycle that is applied to the second type of perishable product, as shown in FIGS. 5 and 6.

In one embodiment, the first duty cycle that is applied to the first type of perishable product may be spaced apart in time from the second duty cycle that is applied to the second type of perishable product, as shown in FIG. 5.

In another embodiment, the first duty cycle that is applied to the first type of perishable product may at least partially overlap in time with the second duty cycle that is applied to the second type of perishable product, as shown in FIG. 6.

In some embodiments, applying a first duty cycle of the pulsed electric field to a first type of perishable product comprises applying the first duty cycle to either a fish product or a meat product.

In some embodiments, applying a second duty cycle of the pulsed electric field to a second type of perishable product comprises applying the second duty cycle of the pulsed electric field to either a fruit product or a vegetable product.

As described previously, a person of ordinary skill in the art would readily appreciate that while FIGS. 5 and 6 describe the inventive aspect of the supercooling with respect to duty cycles only, other parameters are also concurrently applied together along with the duty cycles in order to apply different magnetic fields and electric fields for different type of perishable products to achieve the supercooling effect. For instance, the signals as shown in FIG. 5 or 6 may vary not just in duty cycles but also in signal parameters such as magnitude, amplitude, direction of magnetic field, direction of electric field, frequency, phase, waveform (e.g., wave shape), etc.

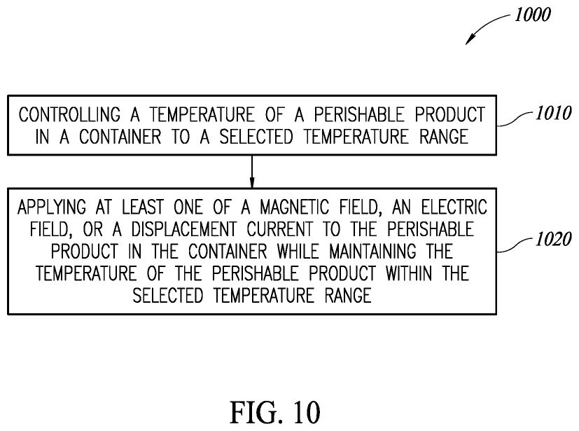

FIG. 10 is a flow chart of a method according to yet another embodiment of the present disclosure.

The method 1000 includes the method of applying different sets of combinations of at least one of a magnetic field, an electric field, or a displacement current based on different parameter types including, but not limited to, power, amplitudes, waveforms, frequencies, and duty cycles.

The method 1000 includes controlling a temperature of a perishable product in a container to a selected temperature range (at 1010). The method 1000 includes applying at least one of a magnetic field, an electric field, or a displacement current to the perishable product in the container while maintaining the temperature of the perishable product within the selected temperature range (at 1020).

In one embodiment, the applying of at least one of a magnetic field, an electric field, or a displacement current to the perishable product includes selecting a combination of power, amplitudes, waveforms, frequencies, and duty cycles of the at least one of a magnetic field, an electric field, or the displacement current.

In one embodiment, the applying of at least one of a magnetic field, an electric field, or a displacement current to the perishable product further includes applying the selected combination of power, amplitudes, waveforms, frequencies, and duty cycles to the perishable product.

In one embodiment, the method 1000 includes applying different selected combinations of power, amplitudes, waveforms, frequencies, and duty cycles based on the different types of perishable items.

FIG. 11 is an example system diagram of a supercooling system including a supercooling apparatus shown in FIG. 1.

A supercooling system 1100 according to the present disclosure includes a supercooling container 1200, a pulsed electric field (PEF) system 1300, an oscillating magnetic field (OMF) system 1400, a controller 1500, a memory 1600 having stored thereon a lookup table 1650, a measurement system 1700, and a temperature controller 1800. The components of the system 1100 is not exhaustive and other components necessary to operate the supercooling method as described in this present disclosure may be included.

The supercooling container 1200 described in FIG. 11 may not be identical but similar to the container 700 explained in conjunction with FIGS. 7A and 7B.

The PEF system 1300 is operatively coupled to the supercooling container 1200 to create pulsed electric fields through rapid discharge of electrical energy within a finite period of time. As explained previously, such pulses follow a pattern known as a waveform, which represents how an electrical current varies over time. Common waveforms for electrical currents include the square wave, the sine wave, the ramp, the sawtooth wave, and the triangular wave. In a squared waveform, the amplitude of the wave alternates at a steady frequency between fixed minimum and maximum values, with the same duration at minimum and maximum. As described elsewhere, in some embodiments, a squared waveform is used in applying a PEF to a perishable product.

In addition to having a waveform, the pulsed electric fields can follow a duty cycle, as discussed briefly above.

The PEF system 1300 includes a function generator 1310 and a power supply 1320. Power supplies used for generating the pulsed electric fields are well known in the art and are commercially available. The power supply 1320 can be a capacitor charging power supply with frequency alternating current (AC). A non-limiting example of a suitable power supply is an integrated-gate-bipolar-transistor based power supply (IGBT).

Electrodes coupled to the power supply are placed such that they are directly or indirectly in contact with the perishable material when it is placed in the supercooling container 1200. Suitable electrode materials include, but are not limited to stainless steel, titanium, gold, and silver. The electrodes can be formed in a variety of shapes, including but not limited to plates, prongs, and conductive films. In one embodiment, the electrodes can further be designed with multiple holes to enhance the circulation of cold air. Depending, for example, on the type of food or other perishable material, different types of electrodes can be selected, such as the side electrodes or the bottom electrodes.

The power supply can provide an input voltage. A suitable, non-limiting peak-to-peak voltage setting is about 5 V. Suitable, non-limiting electrical currents provided by the power supply can be up to about 0.04 A. The current produced by the power supply can also be characterized by a working frequency. A suitable, non-limiting example of a frequency for the pulsed electric fields applied to supercooling is less than 50 kHz.

The pulsed electric fields can be controlled using function generators 1310. Suitable function generators are commercially available and well-known in the art. Function generators control square wave forms with various duty cycles and working frequencies.

The OMF system 1400 is operatively coupled to the supercooling container 1200 to apply an oscillating magnetic field to a perishable material as described herein. The oscillating magnetic field may be generated, for example, by using one or more electromagnets or by a combination of an electromagnet with a permanent magnet.

Examples of suitable systems for producing an oscillating magnetic field include, but are not limited to, one electromagnet located to one side of the perishable material, two electromagnets located on opposite sides of a perishable material, or an electromagnet and a permanent magnet located on opposite sides of a perishable material. In some embodiments, more than one set of electromagnets may be utilized. For example, in some embodiments, four electromagnets are located at each side of the container holding the perishable material.

In other embodiments, in order to provide an oscillating magnetic field within the supercooling container 1200, a solenoid configuration may be used.

Like the pulsed electric field, a pulsed magnetic field can be generated with a function generator 1410 and power supply 1420 to the electromagnet. Suitable power supplies are commercially available, and may be, for example, an IGBT as described above. The oscillating magnetic field is regulated via the function generator 1410 through an input voltage, which can range from 50 to 150 V at a frequency of 1-20 Hz.

A suitable, non-limiting example of an oscillating magnetic field is a pulse type field with an intensity ranging from −150 mT to 150 mT. Another non-limiting example includes a combined magnetic flux density by permanent magnet and electromagnet oscillated between 50 to 500 mT per second.

An oscillating magnetic field (OMF) generator comprising solenoid coils can create an oscillating magnetic field with a defined intensity as measured in the container of the supercooling apparatus.

The supercooling system 1100 includes a controller 1500 (or controllers 1500) to control the PEF generator, OMF generator, and other components operatively coupled to the controller 1500. In some embodiments, the controller 1500 is set to deliver an applied PEF as a squared waveform, as described herein. An example of an applied PEF delivered as a squared waveform at high frequency (20 Hz) with a programmed duty cycle is shown in FIG. 4. In this non-limiting example, the cooling decays from an initial food temperature to a supercooling temperature during Phase 1 with oscillating magnetic field (OMF) on and PEF off. In Phase 2 (immediately after supercooling is reached), both OMF and PEF applied with programmed duty cycles are used to maintain the supercooling temperature of the food product.

The controller 1500 may perform the various functions and methods of performing supercooling as described herein. The controller 1500 may include any processor-based or microprocessor-based system including systems using microcontrollers, integrated circuit, chip, microchip, reduced instruction set computers (RISC), application specific integrated circuits (ASICs), field-programmable gate arrays (FPGAs), graphical processing units (GPUs), logic circuits, and any other circuit or processor capable of executing the various operations and functions described herein.

In some embodiments, the controller 1500 may be operatively coupled to an artificial intelligence image processing circuitry so that part of the image analysis performed by the controller 1500 can utilize the artificial intelligence image processing circuitry that is trained to interpret various images of the perishable products in order to accurately determine both the type and amount of perishable products in the supercooling container 1200.

In one or more embodiments, the controller 1500 may be operatively coupled to the supercooling container but is not limited to being directly and physically coupled to the container. For instance, the container may be communicatively coupled to the controller 1500 such that wireless data exchange is established using various wireless communication technologies. That is, the analysis by the controller 1500 may be performed elsewhere that is away from the actual supercooling container. For instance, sensor measurements or sensed data may be uploaded using any type of suitable wireless communication schemes such as Wi-Fi, Bluetooth, Internet, or other means, in order to perform the data analysis entirely remotely or partially remotely. The optimized control instructions (including parameter setting information such as amplitude, magnitude, frequency, phase relationship, waveforms, duty cycles, direction of which electric field is applied, direction of which magnetic field is applied, or the like) can be returned to the supercooling apparatus 100 by the same communication means and have the optimized control instructions executed. These optimized control instructions may cause the electric field function generator 1310 or the magnetic field function generator 1410 or both to generate the suitable electric field and magnetic field based on the different type of perishable products within the supercooling container.

The supercooling system 1100 includes a memory 1600. The memory 1600 is operatively coupled to the controller 1500 so that the controller 1500 can retrieve various information including the lookup table 1650 stored in the memory as explained in connection with FIGS. 7A and 7B. The memory may include Random Access Memory (RAM) and Read Only Memory (ROM). The memory may be in a form of a storage device, which may be a hard disk drive or a removable storage drive such as an optical disk drive, solid state disk drive (e.g., flash ROM), and the like. The storage device may also be other similar means for loading computer programs or other instructions into the computer or processor.

The supercooling system 1100 includes a measurement system 1700 that includes the various sensors as described in connection with FIGS. 7A and 7B. The measurement system may use the various sensors coupled to the supercooling container 1200 to obtain data and transmit to the controller 1500 for analysis. As described in connection with FIGS. 7A and 7B, the non-limiting examples of sensors include image sensors, weight sensors, distance sensors (e.g., range sensors, time of flight sensors, or the like), quantity sensors, or the like.

The supercooling system 1100 includes a temperature controller 1800 which controls the temperature of the supercooling container 1200.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
controlling a temperature of a perishable product in a container to a selected temperature range;
applying an oscillating magnetic field to the perishable product in the container while maintaining the temperature of the perishable product within the selected temperature range;
applying a pulsed electric field to the perishable product in the container concurrently with the oscillating magnetic field while maintaining the temperature of the perishable product within the selected temperature range, the pulsed electric field having one or more signal parameters; and
adjusting the one or more signal parameters of the pulsed electric field based on a type of the perishable product.

2. The method of claim 1, wherein the selected temperature range is between 0° Celsius and −80° Celsius.

3. The method of claim 1, wherein applying an oscillating magnetic field to the perishable product in the container includes:
applying the oscillating magnetic field having a selected frequency range,
wherein the selected frequency range is less than 50 Hz.

4. The method of claim 1, wherein an orientation of the oscillating magnetic field relative to the electric file is orthogonal.

5. The method of claim 1, wherein applying an oscillating magnetic field to the perishable product in the container includes:
applying the oscillating magnetic field having a selected magnetic flux density range,
wherein the selected magnetic flux density range is between 0 mT and 100 mT.

6. The method of claim 1, wherein an orientation of the oscillating magnetic field relative to the electric file is parallel.

7. The method of claim 1, wherein an orientation of the oscillating magnetic field relative to the electric file is at a selected angle.

8. The method of claim 1, wherein adjusting the one or more signal parameters of the pulsed electric field based on a type of the perishable product comprises applying a first waveform having an ON period during a first period for a first type of perishable product and applying a second waveform having ON period during a second period for a second type of perishable product.

9. The method of claim 8, wherein the ON period of the first waveform during the first period and the ON period of the second waveform during the second period do not overlap with each other.

10. The method of claim 9, wherein the ON period of the first waveform during the first period and the ON period of the second waveform during the second period at least partially overlap with each other.

11. The method of claim 1, wherein the one or more signal parameters include waveform, amplitude, frequency, duty cycle, or phase information.

12. A method, comprising:
controlling a temperature of one or more perishable products in a container to a selected temperature range;
applying an oscillating magnetic field to the one or more perishable products in the container while maintaining the temperature of the perishable product within the selected temperature range;
applying a pulsed electric field to the one or more perishable products in the container concurrently with the oscillating magnetic field while maintaining the temperature of the perishable product within the selected temperature range, the pulsed electric field having a selected duty cycle;
applying a first duty cycle of the pulsed electric field to a first type of perishable product of the one or more perishable products; and
applying a second duty cycle of the pulsed electric field to a second type of perishable product of the one or more perishable products,
wherein the first type of perishable product and the second type of perishable product are different from each other.

13. The method of claim 12, comprising:
identifying the first and second types of perishable products based on a symbol associated with first and second types of perishable products, respectively.

14. The method of claim 13, wherein the symbol includes a machine-readable symbol.

15. The method of claim 12, comprising:
identifying the first and second types of perishable products based on image processing via a camera module.

16. The method of claim 12, wherein the first duty cycle includes a first period that includes high signal pulses and the second duty cycle includes a second period that includes high signal pulses, and wherein at least some of the high signal pulses of the first period of the first duty cycle at least partially overlap with at least some of the high signal pulses of the second period of the second duty cycle.

17. The method of claim 12, wherein the first duty cycle includes a first period that includes high signal pulses and the second duty cycle includes a second period that includes high signal pulses, and wherein the high signal pulses of the first period of the first duty cycle and the high signal pulses of the second period of the second duty cycle do not overlap with each other.

18. The method of claim 12, wherein the pulsed electric field is provided as a pulsed squared waveform.

19. A method, comprising:
controlling a temperature of a perishable product in a container to a selected temperature range; and
applying at least one of a magnetic field or an electric field to the perishable product in the container while maintaining the temperature of the perishable product within the selected temperature range, the applying of at least one of a magnetic field or an electric field to the perishable product including:
selecting a combination of power, amplitudes, waveforms, frequencies, and duty cycles of the at least one of a magnetic field or an electric field; and
applying the selected combination of power, amplitudes, waveforms, frequencies, and duty cycles to the perishable product.

20. The method of claim 19, wherein the perishable product includes different types of perishable items, the method comprising:
applying different selected combinations of power, amplitudes, waveforms, frequencies, and duty cycles based on the different types of perishable items.

21. A system, comprising:
a supercooling container;
a pulsed electric field generator operatively coupled to the supercooling container, the pulsed electric field generator, in operation, applies pulsed electric field to the supercooling container;
an oscillating magnetic field generator operatively coupled to the supercooling container, the oscillating magnetic field generator, in operation, applies oscillating magnetic field to the supercooling container;
a temperature controller operatively coupled to the supercooling container, the temperature controller, in operation, controls a temperature of a perishable product in the supercooling container to a selected temperature range;
a controller operatively coupled to the supercooling container, the controller, in operation:
causes the oscillating magnetic field generator to apply the oscillating magnetic field to the perishable product in the supercooling container while maintaining the temperature of the perishable product within the selected temperature range;
causes the pulsed electric field generator to apply the pulsed electric field to the perishable product in the container concurrently with the oscillating magnetic field while maintaining the temperature of the perishable product within the selected temperature range, the pulsed electric field having a selected duty cycle; and
causes the pulsed electric field generator to adjust the selected duty cycle of the pulsed electric field based on a type of the perishable product.

22. The system of claim 21, wherein adjusting the selected duty cycle of the pulsed electric field based on a type of the perishable product comprises applying a first duty cycle of the selected duty cycle when the perishable product is a first type of perishable product.

23. The system of claim 22, wherein adjusting the selected duty cycle of the pulsed electric field based on a type of the perishable product comprises applying a second duty cycle of the selected duty cycle when the perishable product is a second type of perishable product different from the first type of perishable product, wherein the second duty cycle and the first duty cycle are different from each other.

24. The system of claim 23, wherein high pulses of a signal having the second duty cycle at least partially overlap with high pulses of a signal having the first duty cycle.

25. The system of claim 23, wherein high pulses of a signal having the second duty cycle do not overlap with high pulses of a signal having the first duty cycle.
